(19) United States
(12) Patent Application Publication
(10) Pub. No.: US 2023/0227619 A1
(43) Pub. Date: Jul. 20, 2023

(54) METHOD FOR PRODUCING HIGH QUALITY BARRIER PACKAGING USING FLUORINATION

(71) Applicant: Inhance Technologies, LLC, Houston, TX (US)

(72) Inventors: Zhenshuo Liu, Missouri City, TX (US); Subramanian Iyer, Katy, TX (US)

(21) Appl. No.: 18/084,770

(22) Filed: Dec. 20, 2022

Related U.S. Application Data
(60) Provisional application No. 63/300,818, filed on Jan. 19, 2022.

(51) Int. Cl. C08J 7/12

(52) U.S. Cl. CPC C08J 7/126; C08J 2323/06; C08J 2323/12; C08J 2323/16

(57) ABSTRACT

The present invention provides methods for reducing extractables from plastic articles and improving barrier properties of such plastic articles. The method includes the steps of: (a) providing a plastic article in a chamber; and (b) providing a fluorination gas and a second gas, such as oxygen or another halogen other than fluorine, in a chamber, thereby exposing the plastic article to the fluorination gas and the second gas. The method produces a treated plastic article that is both low in extractable components and suitable for use in packaging formulations containing an organic ingredient.

### CROSS-REFERENCE

This application claims priority under 35 U.S.C. 119(e) to U.S. Provisional Application Ser. No. 63/300,818 filed on Jan. 19, 2022, which is incorporated herein by reference in its entirety.

### FIELD OF INVENTION

The present invention relates generally to the fluorination of polyolefin containers. More specifically, the present invention relates to a method for producing high quality barrier packaging with minimal impurities.

### BACKGROUND OF THE INVENTION

High Density Polyethylene (HDPE) containers are commonly used in packaging for food and beverages, toys, cosmetics, household cleaning products, motor oil, antifreeze, industrial chemicals, agrochemicals, and gasoline. HDPE is economical, blow-moldable, resistant to both UV and many chemicals, and recyclable.

The expectation of a packaging is that the product characteristics (e.g., taste, smell, color, etc.) and amount (e.g., weight) do not change during normal shelf-life. Product characteristics may be impacted if the product extracts components within the packaging. Ideally the product contains a low amount of extractable components.

In most cases, maintaining the amount of product in the package is a practical concern, for example, not wanting product seepage making a mess on shelves in the grocery store. In some cases, for example if the package holds a hazardous material, the rate of permeation of the material through the package is a more serious matter, subject to regulation. For example, 49 CFR Appendix B to Part 173, Procedure for Testing Chemical Compatibility and Rate of Permeation in Plastic Packaging and Receptacle, gives the testing procedures and acceptable permeation limits for a hazardous material in a plastic container.

There is a need for plastic containers that provide both a low amount of extractable components and low permeation rates.

### BRIEF SUMMARY OF THE INVENTION

According to an embodiment of the present invention, a method of improving the quality of products made with plastics is provided. The method comprises the steps of (a) providing a plastic article in a chamber; (b) providing a fluorination gas and a second gas in the chamber; (c) exposing the plastic article to the fluorination gas and the second gas for a period of time ranging from 5 minutes to 600 minutes to produce a treated plastic article; (d) evacuating the fluorination gas and the second gas from the chamber; (e) returning the chamber to atmospheric conditions; and (f) removing the treated plastic article from the chamber. The plastic article comprises polyolefin. The second gas comprises oxygen and/or a halogen other than fluorine. The treated plastic article comprises less than 100 ppb perfluoroalkyl substances as determined by analyzing a first solvent extract for the perfluoroalkyl substances based upon standard CEN/TS 15968:2010. The first solvent consists essentially of a 50/50 mixture of methanol and ammonia-methanol (0.6%). The first solvent and a first treated sample weighing at least one gram are sonicated for a period of 2 hours at a temperature of 60° C. to produce the first solvent extract.

According to yet another embodiment of the present invention, a method of improving the quality of products made with plastics is provided. The method comprises the steps of (a) providing a plastic container in a chamber; (b) providing a fluorination gas and a second gas in the chamber; (c) exposing the plastic container to the fluorination gas and the second gas for a period of time ranging from 5 minutes to 600 minutes to produce a treated plastic container; (d) evacuating the fluorination gas and the second gas from the chamber; (e) returning the chamber to atmospheric conditions; and (f) removing the treated plastic container from the chamber. The plastic container comprises polyethylene, polypropylene, and/or copolymers thereof. The second gas comprises oxygen and/or a halogen other than fluorine. The treated plastic container comprises less than 25 ppb C5 perfluoroalkyl substances and less than 10 ppb C6 to C20 perfluoroalkyl substances as determined by analyzing a methanol extract for the perfluoroalkyl substances according to modified EPA 537.1. A first treated container sample is the treated plastic container or a first treated smaller analog of the plastic container. Methanol is added to the first treated container sample and the first treated container sample is shaken and/or rotated to ensure the methanol contacts as much of the first treated container sample as possible for a time period of one minute to produce the methanol extract. The second treated container sample is the treated plastic container or a second treated smaller analog of the plastic container. The second treated plastic container sample, filled with a formulation containing an organic ingredient, maintains at least 95% of an initial filled weight after being held at a temperature of 50° C. for 28 days. The organic ingredient is selected from the group consisting of 1,1,1-trichloroethane, xylene, heavy fuel oil, naphtha, toluene, mineral spirits, carbon tetrachloride, and/or turpentine.

According to yet another embodiment of the present invention, a method of improving the quality of products made with plastics is provided. The method comprises the steps of (a) providing a plastic container in a chamber; (b) providing a fluorination gas and a second gas in the chamber; (c) exposing the plastic container to the fluorination gas and the second gas for a period of time ranging from 5 minutes to 600 minutes to produce a treated plastic article; (d) evacuating the fluorination gas and the second gas from the chamber; (e) returning the chamber to atmospheric conditions; and (f) removing the treated plastic container from the chamber. The plastic container comprises polyolefin. The second gas comprises oxygen and/or a halogen other than fluorine. During step (c), (i) the temperature in the chamber ranges from 25° C. to 80° C., (ii) the total pressure in the chamber ranges from 1 mmHg to 1520 mmHg, and (iii) the partial pressure of fluorine equivalents (P_{FG}) to a partial pressure of the second gas (P_{SG}) ranges from 3:1 to 35:1. The treated plastic container comprises less than 100 ppb perfluoroalkyl substances as determined by analyzing a solvent extract for the perfluoroalkyl substances based upon standard CEN/TS 15968:2010. The solvent consists essentially of a 50/50 mixture of methanol and ammonia-methanol (0.6%). The solvent and a treated sample weighing at least one gram are sonicated for a period of 2 hours at a temperature of 60° C. to produce the solvent extract. The treated plastic container or a treated smaller analog of the plastic container, filled with a formulation containing an organic ingredient maintains at least 95%, of an initial filled weight after being held at a temperature of 50° C. for 28 days.

According to yet another embodiment of the present invention, a treated plastic article or a treated plastic container made by the inventive methods disclosed herein is provided.

### DETAILED DESCRIPTION OF THE INVENTION

The present invention provides a method of improving the quality of products made with plastics. The method comprises the steps of (a) providing a plastic article in a chamber; (b) providing a fluorination gas and a second gas in the chamber; (c) exposing the plastic article to the fluorination gas and the second gas for a period of time ranging from 5 minutes to 600 minutes to produce a treated plastic article; (d) evacuating the fluorination gas and the second gas from the chamber; (e) returning the chamber to atmospheric conditions; and (f) removing the treated plastic article from the chamber. The plastic article comprises polyolefin. The second gas comprises oxygen and/or a halogen other than fluorine. The treated plastic article comprises less than 100 ppb perfluoroalkyl substances as determined by analyzing a first solvent extract for the perfluoroalkyl substances based upon standard CEN/TS 15968:2010. The first solvent consists essentially of a 50/50 mixture of methanol and ammonia-methanol (0.6%). The first solvent and a first treated sample weighing at least one gram are sonicated for a period of 2 hours at a temperature of 60° C. producing the first solvent extract.

The present invention may be understood more readily by reference to the following detailed description of the invention. It is to be understood that this invention is not limited to the specific devices, methods, conditions, or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

It is to be understood that the mention of one or more method steps does not preclude the presence of additional method steps before or after the combined recited steps or intervening method steps between those steps expressly identified. Moreover, the lettering of method steps or ingredients is a conventional means for identifying discrete activities or ingredients and the recited lettering can be arranged in any sequence, unless otherwise indicated. Method steps that begin with the word “optionally” may occur, but are not required to occur.

As used herein, the term “and/or”, when used in a list of two or more items, means that any one of the listed items can be employed by itself, or any combination or two or more of the listed items can be employed. For example, if a composition is described as containing compounds A, B, “and/or” C, the composition may contain A alone; B alone; C alone; A and B in combination; A and C in combination; B and C in combination; or A, B, and C in combination.

As used herein, the term “plastic article”, refers to any useful item made primarily of one or more polymers. The “plastic article” may also contain polymer additives typically used in producing plastic articles. Non-limiting examples of polymer additives include plasticizers, fillers, dyes, stabilizers, blowing agents, and flame retardants.

As used herein, the term “chamber”, refers to at least one piece of process equipment capable of enclosing the plastic article, the fluorination gas, and the second gas as well as excluding atmospheric gases at the process conditions.

As used herein, the term “fluorination gas”, refers to a gas comprising fluorine, chlorine trifluoride, and/or nitrogen trifluoride. The “fluorination gas” may also contain inert elements and/or compounds. As used herein, “the partial pressure of the fluorination gas (P_{FG})” is the partial pressure of fluorine equivalents (i.e., the partial pressure of fluorine when the “fluorination gas” comprises fluorine and the partial pressure of fluorine equivalents when the “fluorination gas comprises” a fluorine compound). Note that as defined, the P_{FG} is independent of any inerts in the “fluorination gas.”

As used herein, the term “second gas”, refers to a gas comprising either oxygen, a halogen, or a halogen containing compound, wherein the halogen is not fluorine. The “second gas” may also contain other reactive or inert elements and/or compounds. As used herein, “the partial pressure of the second gas (P_{SG}) is the partial pressure of oxygen and/or the partial pressure of halogen (i.e., the partial pressure of halogen when the “second gas” comprises halogen and the partial pressure of halogen equivalents when the “second gas comprises” a halogen compound). Note that as defined, the P_{SG} is independent of any “inerts in the second gas.”

As used herein, the term “polyolefin”, refers to a polymer produced from at least one olefin. Common polyolefins include, but are not limited to, polyethylene, polypropylene, and copolymers of ethylene and propylene.

As used herein, the term “extractable components”, refers to the components that are extracted from a plastic article, or a sample thereof; the extractable components can be in a solvent or can be in the headspace above a plastic article or sample thereof.

As used herein, the term “perfluoroalkyl substances” refer to C4 to C20 perfluorocarbons and/or perfluoroethers with a functional end group. Non-limiting examples of the functional end group include carboxylic acids, sulfonic acids, and ammonium salts.

As used herein, “a treated sample”, refers to at least a portion of a prototypical treated plastic article to which analytical testing is applied; the analytical testing takes place on a sample from a treated plastic article, or a treated plastic article, that has been subject to the method of the present invention. As used herein, the term “an untreated sample”, refers to at least a portion of a prototypical plastic article to which analytical testing is applied; the analytical testing takes place on a sample from a plastic article, or a plastic article, that has not been subject to the method of the present invention.

As used herein, the term “plastic container”, refers to a plastic article in the form of a receptacle or enclosure for retaining a liquid solid, or gas. The size is not particularly limited as long as the “plastic container” can fit inside the chamber. Non-limiting examples of uses for plastic containers include cosmetic packaging, household cleaning packaging, industrial solvent packaging, and fuel tanks.

As used herein, the term “treated plastic article is suitable for use in packaging formulations containing an organic ingredient” refers to the ability for the plastic article to be used in the packaging of formulations containing an organic ingredient, whether the article is a plastic container or another plastic article such as a cap or lid used in packaging. To be suitable for use in packaging formulations containing an organic ingredient, the treated plastic article has an acceptably low permeation rate of the formulation. As used herein, “the treated plastic container is suitable for packaging formulations containing an organic ingredient”, refers to the ability of a filled, treated plastic container to maintain at least 95% of its initial weight when the filled, treated plastic container is subject to 50° C. for 28 days. As used herein, the term “formulations containing an organic ingredient” refers to any liquid comprising organic molecules. A “formulation” may optionally contain aqueous and/or other inorganic components.

As used herein, the term “smaller analog of the plastic container”, refers to a second plastic container that is made by the same process and of the same material as the plastic container and simply differs from the plastic container in that it is smaller. For reasons of practicability, some regulations allow barrier testing to be conducted on a “smaller analog of the plastic container.” As used herein, the term “treated smaller analog of the plastic container”, refers to a second plastic container that is made by the same process and of the same material as the plastic container and simply differs from the plastic container in that it is smaller and that it has been subject to the method of the present invention.

As used herein, the term “rigid article”, refers to a plastic article that is classified under the Rigid Packaging Market. As used herein, the term “rigid container”, refers to a rigid article in the form of a receptacle or enclosure for retaining a liquid. Examples of rigid articles include, but are not limited to, bottles, caps, pails, lids, trays, drums, vials, cartridges, intermediate bulk containers (IBC) and tanks. Common molding processes to produce “rigid articles” include, but are not limited to, blow molding, injection molding, compression molding, thermoforming, and rotomolding.

As used herein, the term “semi-rigid article”, refers to plastic articles that have a degree of flexibility, but can retain their shape. Examples include, but are not limited to, stand-up pouches (SUP) and tubes (such as for toothpaste).

As used herein, the term “recycled resin”, refers to material that has been recovered from a plastic article and is usable for making future plastic articles. “Recycled resin” broadly includes both “post-industrial recycled (PIR) resin” and “post-consumer recycled (PCR) resin”. As used herein the term “post-industrial recycled (PIR) resin”, refers to material recovered from within an industrial setting, e.g., defective articles, scrap, etc. As used herein, the term “post-consumer recycled (PCR) resin”, refers to the recycled material from consumer plastic waste. “PCR resin” from plastic packaging has been exposed to the material that was contained in the plastic packaging. In contrast, as used herein, the term “virgin resin” refers to a polymer, such as polyolefin, that has been produced from its monomers and has not yet been formed into a plastic article.

The present embodiment includes (a) providing a plastic article in the chamber. The plastic article comprises polyolefin. The molecular weight of, the amount of branching of, and the particular olefins included in the polyolefin are not particularly limited as long as the polyolefin is suitable for producing the plastic article. In some aspects, the polyolefin comprises polyethylene, polypropylene, and/or copolymers thereof. In some aspects, the polyolefin comprises high-density high-molecular-weight polyethylene, high-density polyethylene (HDPE), linear-low-density polyethylene (LLDPE), low-density polyethylene (LDPE) and/or polypropylene. In some aspects the polyolefin comprises high-density polyethylene (HDPE), low-density polyethylene (LDPE) and/or polypropylene. In some aspects, the polyolefin comprises high-density polyethylene (HDPE) and/or low-density polyethylene (LDPE).

The present embodiment includes (b) providing a fluorination gas and a second gas in the chamber. In some aspects, the fluorination gas comprises fluorine in a range of 1-100% by volume (e.g., the fluorination gas being pure fluorine, or the fluorination gas being a gas mixture including fluorine mixed with at least one inert gas such as nitrogen, carbon dioxide, and/or argon). In some aspects, the fluorination gas comprises 5 vol % to 95 vol % fluorine, 10 vol % to 90 vol % fluorine, or 20 vol % to 75 vol % fluorine. In some aspects, the fluorination gas comprises 1 vol % to 100 vol % fluorine; or 10 vol % to 100 vol % fluorine; or 20 vol % to 100 vol % fluorine; or 30 vol % to 100 vol % fluorine; or 40 vol % to 100 vol % fluorine. In some aspects, the fluorination gas comprises 99 vol % to 0 vol % of an inert gas. Other non-limiting examples include 99 vol % to 10 vol %; 99 vol % to 20 vol %; or 99 vol % to 30 vol % 95 vol % to 5 vol %; 90 vol % to 10 vol %; and 80 vol % to 25 vol % of inert gas. In some aspects, the fluorination gas comprises 99 vol % to 0 vol % of an inert gas, and the inert gas comprises nitrogen. In some aspects, the fluorination gas comprises 99 vol % to 0 vol % of an inert gas; or 99 vol % to 10 vol % of an inert gas; 99 vol % to 20 vol % of an inert gas; or 99 vol % to 30 vol % of an inert gas, and the inert gas comprises nitrogen.

The second gas comprises oxygen and/or a halogen other than fluorine. When the second gas comprises oxygen, the oxygen can be provided in the chamber through partial evacuation of the air originally in the chamber and/or by feeding a stream of the second gas comprising oxygen to the chamber. When the second gas comprises a halogen other than fluorine, the halogen other than fluorine can be provided in the chamber by feeding a stream of the second gas comprising the halogen other than fluorine to the chamber. When the second gas comprises oxygen and a halogen other than fluorine, the oxygen can be provided in the chamber through partial evacuation of the air originally in the chamber and/or be feeding a stream of the second gas comprising oxygen to the chamber and the halogen other than fluorine can be provided in the chamber by feeding a stream of the second gas comprising the halogen other than fluorine to the chamber. The stream of the second gas comprising oxygen and the stream of the second gas comprising the halogen other than fluorine can be a combined stream fed to the chamber or two streams fed separately to the chamber.

In some aspects, the second gas comprises oxygen and providing the second gas to the chamber consists of a partial evacuation of the chamber before step (b) and/or feeding a stream of the second gas comprising oxygen to the chamber during step (b). In some aspects, the second gas comprises a halogen other than fluorine and providing the second gas comprising the halogen other than fluorine in the chamber consists of feeding a stream of the second gas comprising 1 vol % to 100 vol % of the halogen other than fluorine; or 10 vol % to 100 vol % of the halogen other than fluorine; or 20 vol % to 100 vol % of the halogen other than fluorine; or 30 vol % to 100 vol % of the halogen other than fluorine; or 40 vol % to 100 vol % the halogen other than fluorine to the chamber. In some aspects, the second gas comprises chlorine.

The present embodiment produces a treated plastic article with a low amount of extractable components and barrier properties suitable for use in packaging formulations containing an organic ingredient.

Among potential extractable components, it is important that perfluoroalkyl substances be minimal. In some aspects, the treated plastic article comprises less than 150 ppb, or 125 ppb, or 100 ppb, or 90 ppb, or 80 ppb, or 70 ppb, or 60 ppb, or 50 ppb, or 40 ppb, or 35 ppb, or 30 ppb, or 25 ppb, or 20 ppb, or 15 ppb, or 12 ppb, or 10 ppb, or 8 ppb, or 5 ppb, or 2 ppb or 1 ppb perfluoroalkyl substances. In some aspects, the treated plastic article is tested for the perfluoroalkyl substances using a first solvent consisting essentially of a 50/50 mixture of methanol and ammonia-methanol (0.6%) or the first solvent consists essentially of methanol. The first solvent and a first treated sample which weighs at least one gram are sonicated for a period of two hours at a temperature of 60° C. producing a first solvent extract. The first solvent extract is analyzed for the perfluoroalkyl substances based upon standard CEN/TS 15968:2010.

In some aspects, the treated plastic article does not comprise perfluoroalkyl substances as demonstrated by an amount of perfluoroalkyl substances in a first solvent below the level of detection (LOD) and/or level of quantification (LOQ) after a first treated sample is tested based upon standard CEN/TS 15968:2010. In some aspects, the LOD is 1 part per billion (ppb) or less. In some aspects, the first treated sample is one of the treated plastic articles. In some aspects, the first treated sample is a part of one of treated plastic articles. In some aspects, the first treated sample is a part of the treated plastic article and the first treated sample weighs at least 300 mg, or at least 1 gram, or at least 10 grams, or at least 20 grams.

In some aspects, the treated plastic article is a treated plastic container, and the treated plastic container comprises less than 25 ppb, or 20 ppb, or 15 ppb, or 12 ppb, or 10 ppb, or 8 ppb, or 5 ppb, or 2 ppb or 1 ppb perfluoroalkyl substances. The analysis is conducted on a treated container sample, and the treated container sample is the treated plastic container or a treated smaller analog of the plastic container. Methanol is added to the treated container sample and the treated container sample is shaken and/or rotated to ensure the methanol contacts as much of the treated container sample as possible for a time period of one minute, producing a methanol extract. The methanol extract is analyzed for the perfluoroalkyl substances according to modified EPA 537.1.

In some aspects the treated plastic article comprises less than 10 ppb, or 8 ppb, or 5 ppb, or 2 ppb or 1 ppb or non-detectable C6 to C20 perfluoroalkyl substances. In some aspects, the treated plastic article comprises less than 25 ppb, or 20 ppb, or 15 ppb, or 12 ppb, or 10 ppb, or 8 ppb, or 5 ppb, or 2 ppb or 1 ppb or non-detectable C4 to C5 perfluoroalkyl substances. In some aspects, the treated plastic article comprises less than 25 ppb, or 20 ppb, or 15 ppb, or 12 ppb, or 10 ppb, or 8 ppb, or 5 ppb, or 2 ppb or 1 ppb or non-detectable C4 perfluoroalkyl substances. In some aspects, the treated plastic article comprises less than 25 ppb, or 20 ppb, or 15 ppb, or 12 ppb, or 10 ppb, or 8 ppb, or 5 ppb, or 2 ppb or 1 ppb or non-detectable C5 perfluoroalkyl substances.

In some aspects, the first solvent is a 50/50 mixture of methanol and methanol-ammonia (0.6%). In some aspects, the first solvent is methanol. In some aspects, the first treated samples weighs at least one gram and the first treated sample and the first solvent are sonicated for a period of 2 hours at a temperature of 60° C.

The method of the present invention produces treated plastic articles suitable for use in packaging formulations containing an organic ingredient. In some aspects, the plastic article is a plastic container and a treated plastic container, or a treated smaller analog of the plastic container, filled with a formulation containing an organic ingredient maintains at least 95%, or at least 96%, or at least 97%, or at least 98%, or at least 99%, or at least 99.5% of an initial filled weight after being held at a temperature of 50° C. for 28 days.

In some aspects, the formulation comprises agricultural chemicals, fuel, fuel additives, cleaners, degreasers, solvents, acetone, d-limonene, terpenes, fragrances, and/or essential oils. In some aspects, the organic ingredient is selected from the group consisting of 1,1,1-trichloroethane, xylene, heavy fuel, naphtha, toluene, mineral spirits, carbon tetrachloride, and turpentine.

In some aspects, the plastic article is in the form of a rigid article or a semi-rigid article. In some aspects, the plastic article is a rigid article selected from the group consisting of bottles, caps, pails, lids, trays, drums, vials, cartridges, intermediate bulk containers (IBC), and tanks. In some aspects, the plastic article is a semi-rigid container selected from the group consisting of stand-up pouches (SUP) and tubes. In some aspects, the plastic article is a plastic container, and the size of the plastic container is not particularly limited so long as it can fit within the chamber. In some aspects, the plastic container ranges in size from 0.5 ml to 20,000 liters, or from 0.5 ml to 10,000 liters, of from 0.5 ml to 5,000 liters, or from 0.5 ml to 2,500 liters, or from 0.5 ml to 1,000 liters, or from 0.5 ml to 500 liters.

The amount of polyolefin contained in the plastic article includes both polyolefin contained in the virgin resin and polyolefin contained in the recycled resin, if present. In some aspects the polyolefin comprises a virgin resin and a recycled resin. In some aspects the recycled resin comprises post-industrial recycled (PIR) resin and/or post-consumer recycled (PCR) resin. In some aspects, the plastic article comprises the recycled resin in an amount of at least 5 wt. %, or least 10 wt. %, or at least 20 wt. %, or at least 30 wt. %, or at least 40 wt. %, or at least 50 wt. %, or at least 60 wt. %, or at least 70 wt. %, or at least 80 wt. %, or at least 90 wt. %, or at least 95 wt. %, or at least 98 wt. %, or at least 99 wt. %.

In some aspects, the recycled resin comprises polyethylene and polypropylene. In some aspects, the recycled resin comprises polyethylene. In some aspects, the recycled resin comprises high-density high-molecular-weight polyethylene, high density polyethylene (HDPE) and/or low-density polyethylene (LDPE). In some aspects recycled resin comprises at least 10 wt. % polyethylene, or at least 20 wt. % polyethylene, or at least 30 wt. % polyethylene, or at least 40 wt. % polyethylene, or at least 50 wt. % polyethylene, or at least 60 wt. % polyethylene, or at least 70 wt. % polyethylene, or at least 80 wt. % polyethylene or at least 90 wt. % polyethylene, or at least 95 wt. % polyethylene, or at least 98 wt. % polyethylene, or at least 99 wt. % polyethylene.

In some aspects the plastic article comprises the recycled resin in an amount ranging from 5 wt. % to 100 wt. %; or 5 wt. % to 99 wt. %; or 5 wt. % to 98 wt. %; or 5 wt. % to 95 wt. %; or 5 wt. % to 90 wt. %; or 5 wt. % to 80 wt. %; or 5 wt. % to 70 wt. %; or 5 wt. % to 50 wt. %; or 5 wt. % to 40 wt. %; or 5 wt. % to 30 wt. %; 10 wt. % to 100 wt. %; or 10 wt. % to 99 wt. %; or 10 wt. % to 98 wt. %; or 10 wt. % to 95 wt. %; or 10 wt. % to 90 wt. %; or 10 wt. % to 80 wt. %; or 10 wt. % to 70 wt. %; or 10 wt. % to 50 wt. %; or 10 wt. % to 40 wt. %; or 10 wt. % to 30 wt. %; or 20 wt. % to 100 wt. %; or 20 wt. % to 99 wt. %; or 20 wt. % to 98 wt. %; or 20 wt. % to 95 wt. %; or 20 wt. % to 90 wt. %; or 20 wt. % to 80 wt. %; or 20 wt. % to 70 wt. %; or 20 wt. % to 50 wt. %; or 20 wt. % to 40 wt. %; or 20 wt. % to 30 wt. %; or 30 wt. % to 100 wt. %; or 30 wt. % to 99 wt. %; or 30 wt. % to 98 wt. %; or 30 wt. % to 95 wt. %; or 30 wt. % to 90 wt. %; or 30 wt. % to 80 wt. %; or 30 wt. % to 70 wt. %; or 30 wt. % to 50 wt. %; or 30 wt. % to 40 wt. %; or 40 wt. % to 100 wt. %; or 40 wt. % to 99 wt. %; or 40 wt. % to 98 wt. %; or 40 wt. % to 95 wt. %; or 40 wt. % to 90 wt. %; or 40 wt. % to 80 wt. %; or 40 wt. % to 70 wt. %; or 40 wt. % to 50 wt. %; or 50 wt. % to 100 wt. %; or 50 wt. % to 99 wt. %; or 50 wt. % to 98 wt. %; or 50 wt. % to 95 wt. %; or 50 wt. % to 90 wt. %; or 50 wt. % to 80 wt. %; or 50 wt. % to 70 wt. %; or 60 wt. % to 100 wt. %; or 60 wt. % to 99 wt. %; or 60 wt. % to 98 wt. %; or 60 wt. % to 95 wt. %; or 60 wt. % to 90 wt. %; or 60 wt. % to 80 wt. %; or 60 wt. % to 70 wt. %; or 70 wt. % to 100 wt. %; or 70 wt. % to 99 wt. %; or 70 wt. % to 98 wt. %; or 70 wt. % to 95 wt. %; or 70 wt. % to 90 wt. %; or 70 wt. % to 80 wt. %; or 80 wt. % to 100 wt. %; or 80 wt. % to 99 wt. %; or 80 wt. % to 98 wt. %; or 80 wt. % to 95 wt. %; or 80 wt. % to 90 wt. %; or 90 wt. % to 100 wt. %; or 90 wt. % to 99 wt. %; or 90 wt. % to 98 wt. %; or 90 wt. % to 95 wt. %; or 95 wt. % to 100 wt. %; or 95 wt. % to 99 wt. %; or 95 wt. % to 98 wt. %.

In some aspects, the plastic article is of a mono-layered construction. By necessity, the single layer will comprise any recycled resin of the plastic article. In some aspects, the plastic article is of a multi-layered construction. In some aspects, the amount of recycled resin is different in one or more of the layers. In some aspects, one or more of the layers comprises the recycled resin in an amount of least 5 wt. %, or least 10 wt. %, or at least 20 wt. %, or at least 30 wt. %, or at least 40 wt. %, or at least 50 wt. %, or at least 60 wt. %, or at least 70 wt. %, or at least 80 wt. %, or at least 90 wt. %, or at least 95 wt. %, or at least 98 wt. %, or at least 99 wt. %.

A combination of the fluorine or fluorine compound in the fluorination gas and the oxygen and/or halogen or halogen compound other than fluorine in the second gas minimizes the extractable components while producing a treated plastic article suitable for use in packaging formulations containing an organic ingredient. In some aspects, during the exposing step (c), a ratio of the partial pressure of fluorine gas (P_{FG}) to the partial pressure of the second gas (P_{SG}) ranges from 1:1 to 50:1, or from 3:1 to 35:1, or from 3:1 to 25:1, or from 3:1 to 20:1, or from 3:1 to 15:1, or from 3:1 to 14:1, or from 3:1 to 13:1, or from 3:1 to 12:1, or from 3:1 to 11:1, or from 3:1 to 10:1, or from 3:1 to 9:1, or from 4:1 to 35:1, or from 4:1 to 25:1, or from 4:1 to 20:1, or from 4:1 to 15:1, or from 4:1 to 14:1, or from 4:1 to 13:1, or from 4:1 to 12:1, or from 4:1 to 11:1, or from 4:1 to 10:1, or from 4:1 to 9:1, or from 5:1 to 35:1, or from 5:1 to 25:1, or from 5:1 to 20:1, or from 5:1 to 15:1, or from 5:1 to 14:1, or from 5:1 to 13:1, or from 5:1 to 12:1, or from 5:1 to 11:1, or from 5:1 to 10:1, or from 5:1 to 9:1. In some aspects, the partial pressure of the second gas is the partial pressure of O₂ plus the partial pressure of Cl₂. In some aspects the partial pressure of the second gas (P_{SG}) is the partial pressure of O₂. In some aspects, the partial pressure of the second gas (P_{SG}) is the partial pressure of Cl₂.

In some aspects, during the exposing step (c), the temperature in the chamber ranges from 0° C. to 150° C.; or ranges from 0° C. to 125° C.; or ranges from 0° C. to 100° C.; or ranges from 0° C. to 80° C.; or ranges from 25° C. to 150° C.; or ranges from 25° C. to 125° C.; or ranges from 25° C. to 100° C.; or ranges from 25° C. to 80° C.

In some aspects, a total pressure of the chamber during the exposing step (c) ranges from 1 mmHg to 1520 mmHg; or ranges from 1 mmHg to 1140 mmHg; or ranges from 1 mmHg to 950 mmHg; or ranges from 1 mmHg to 760 mmHg; or ranges from 1 mmHg to 700 mmHg; or ranges from 1 mmHg to 600 mmHg; or ranges from 5 mmHg to 1520 mmHg; or ranges from 5 mmHg to 1140 mmHg; or ranges from 5 mmHg to 950 mmHg; or ranges from 5 mmHg to 760 mmHg; or ranges from 5 mmHg to 700 mmHg; or ranges from 5 mmHg to 600 mmHg; or ranges from 5 mmHg to 500 mmHg; or ranges from 5 mmHg to 400 mmHg; or ranges from 5 mmHg to 300 mmHg; or ranges from 5 mmHg to 200 mmHg; or ranges from 5 mmHg to 100 mmHg; or ranges from 5 mmHg to 50 mmHg; or ranges from 50 mmHg to 1520 mmHg; or ranges from 50 mmHg to 1140 mmHg; or ranges from 50 mmHg to 950 mmHg; or ranges from 50 mmHg to 760 mmHg; or ranges from 50 mmHg to 700 mmHg; or ranges from 50 mmHg to 600 mmHg; or ranges from 50 mmHg to 500 mmHg; or ranges from 50 mmHg to 400 mmHg; or ranges from 50 mmHg to 300 mmHg; or ranges from 50 mmHg to 200 mmHg; or ranges from 100 mmHg to 1520 mmHg; or ranges from 100 mmHg to 1140 mmHg; or ranges from 100 mmHg to 950 mmHg; or ranges from 100 mmHg to 760 mmHg; or ranges from 100 mmHg to 700 mmHg; or ranges from 100 mmHg to 600 mmHg; or ranges from 100 mmHg to 500 mmHg; or ranges from 100 mmHg to 400 mmHg; or ranges from 100 mmHg to 300 mmHg; or ranges from 100 mmHg to 200 mmHg.

In some aspects, a partial pressure of fluorine in the chamber during step (c) ranges from 1 mmHg to 1520 mmHg; or ranges from 1 mmHg to 1520 mmHg; or ranges from 1 mmHg to 1140 mmHg; or ranges from 1 mmHg to 950 mmHg; or ranges from 1 mmHg to 760 mmHg; or ranges from 1 mmHg to 700 mmHg; or ranges from 1 mmHg to 600 mmHg; or ranges from 5 mmHg to 1520 mmHg; or ranges from 5 mmHg to 1140 mmHg; or ranges from 5 mmHg to 950 mmHg; or ranges from 5 mmHg to 760 mmHg; or ranges from 5 mmHg to 700 mmHg; or ranges from 5 mmHg to 600 mmHg; or ranges from 5 mmHg to 500 mmHg; or ranges from 5 mmHg to 400 mmHg; or ranges from 5 mmHg to 300 mmHg; or ranges from 5 mmHg to 200 mmHg; or ranges from 5 mmHg to 100 mmHg; or ranges from 5 mmHg to 50 mmHg; or ranges from 50 mmHg to 1520 mmHg; or ranges from 50 mmHg to 1140 mmHg; or ranges from 50 mmHg to 950 mmHg; or ranges from 50 mmHg to 760 mmHg; or ranges from 50 mmHg to 700 mmHg; or ranges from 50 mmHg to 600 mmHg; or ranges from 50 mmHg to 500 mmHg; or ranges from 50 mmHg to 400 mmHg; or ranges from 50 mmHg to 300 mmHg; or ranges from 50 mmHg to 200 mmHg; or ranges from 100 mmHg to 1520 mmHg; or ranges from 100 mmHg to 1140 mmHg; or ranges from 100 mmHg to 950 mmHg; or ranges from 100 mmHg to 760 mmHg; or ranges from 100 mmHg to 700 mmHg; or ranges from 100 mmHg to 600 mmHg; or ranges from 100 mmHg to 500 mmHg; or ranges from 100 mmHg to 400 mmHg; or ranges from 100 mmHg to 300 mmHg; or ranges from 100 mmHg to 200 mmHg.

In some aspects, a partial pressure of the oxygen or the halogen during step (c) ranges from 0 mmHg to 1519 mmHg; or ranges from 0 mmHg to 1139 mmHg; or ranges from 0 mmHg to 949 mmHg; or ranges from 0 mmHg to 759 mmHg; or ranges from 0 mmHg to 699 mmHg; or ranges from 0 mmHg to 599 mmHg; or ranges from 1 mmHg to 1519 mmHg; or ranges from 1 mmHg to 1139 mmHg; or ranges from 1 mmHg to 949 mmHg; or ranges from 1 mmHg to 759 mmHg; or ranges from 1 mmHg to 699 mmHg; or ranges from 1 mmHg to 599 mmHg; or ranges from 5 mmHg to 700 mmHg; or ranges from 5 mmHg to 600 mmHg; or ranges from 5 mmHg to 300 mmHg; or ranges from 5 mmHg to 100 mmHg; or ranges from 5 mmHg to 80 mmHg; or ranges from 5 mmHg to 50 mmHg.

In some aspects, the plastic article is exposed to the fluorination gas for a time period ranging from 5 minutes to 600 minutes; or ranging from 5 minutes to 300 minutes; or ranging from 5 minutes to 150 minutes; or ranging from 5 minutes to 60 minutes; or ranging from 5 minutes to 30 minutes; or ranging from 5 minutes to 20 minutes; or ranging from 10 minutes to 1200 minutes; or ranging from 10 minutes to 600 minutes; or ranging from 10 minutes to 300 minutes; or ranging from 10 minutes to 150 minutes; or ranging from 10 minutes to 60 minutes; or ranging from 10 minutes to 30 minutes; or ranging from 10 minutes to 20 minutes.

In some aspects, a second treated sample is one of the treated plastic articles. In some aspects, the second treated sample is a part of one of the treated plastic articles. In some aspects, a second treated sample is a part of one of the treated plastic article and the second treated sample weighs at least 300 mg, or at least 1 gram, or at least 10 grams, or at least 20 grams. In some aspects, a first portion of a second solvent is exposed to the second treated sample, whereby the first portion of the second solvent comprises a first set of extractable components from the second treated sample. In some aspects, an amount of the first set of extractable components in the first portion of the second solvent is measured using liquid chromatography-mass spectroscopy (LC-MS). In some aspects, the second solvent comprises hexane, xylene, methanol, ammonia, toluene, mineral spirits, and/or water. In some aspects, the solvent is selected from the group consisting of hexane, xylene, methanol, ammonia, toluene, mineral spirits, and/or water.

In some aspects, the extractable components are selected from the group consisting of perfluoroalkyl substances, limonene, Beta pinene, Acetic acid hexyl ester, 1-dodecene, Eucalyptol, L-alpha-Terpineol, Octanal, Nonanal, Decanal, Acetic acid phenylmethyl ester, Heptanoate, Benzene, 1-ethyl-3,5-dimethyl-, Naphthalene, and/or Benzyl alcohol. In some aspects, the extractable components are selected from the group consisting of perfluoroalkyl substances, limonene, Beta pinene, Acetic acid hexyl ester, and/or 1-dodecene. In some aspects, the extractable components are selected from the group consisting of Acetic acid hexyl ester, Eucalyptol, L-alpha-Terpineol, Octanal, Nonanal, Decanal, Acetic acid phenylmethyl ester, Heptanoate, Benzene, 1-ethyl-3,5-dimethyl-, Naphthalene, and/or Benzyl alcohol.

In some aspects, a second untreated sample is one of the plastic articles. In some aspects, the second untreated sample is a part of one of the plastic articles. In some aspects, a second untreated sample is a part of one of the plastic article and the second untreated sample weighs at least 300 mg, or at least 1 gram, or at least 10 grams, or at least 20 grams. In some aspects, a second portion of the second solvent is exposed to the second untreated sample, whereby the second portion of the second solvent comprises a second set of extractable components from the second untreated sample. In some aspects, an amount of the second set of extractable components in the second portion of the second solvent is measured using liquid chromatography-mass spectroscopy (LC-MS). In some aspects, the second treated sample and second untreated sample are substantially similar in size and the first portion of the second solvent and the second portion of the second solvent are substantially similar in volume. In some aspects, a total weight of the first set of extractable components divided by a total weight of the second set of extractable components, on a percentage basis, is less than 1%, or less than 5%, or less than 10% or less than 20% or less than 30% or less than 40% or less than 50% or less than 60%, or less than 70%, or less than 80%.

A quick screening test can be used to indicate the relative permeability of an HDPE plastic article and a treated HDPE plastic article. In some aspects, a third treated sample is, a) weighed, b) sealed in a glass jar with 150 ml of toluene for 2 hours at 25° C., c) dried with a cloth, and d) re-weighed to determine a toluene absorption of the third treated sample; and a third untreated sample is, a) weighed, b) sealed in a glass jar with 150 ml of toluene held for 2 hours at 25° C., c) dried with a cloth, and d) re-weighed to determine a toluene absorption of the third untreated sample. In some aspects, the third treated sample is a nominal 3.5-gram piece of the treated plastic article, and the third untreated sample is a nominal 3.5-gram piece of the plastic article. In some aspects, the plastic article comprises HDPE, and the percent weight increase of the third treated sample divided by the percent weight increase of the third untreated sample is less than 15%, or less than 10%, or less than 8%, or less than 4% or less than 1%.

According to yet another embodiment of the present invention, a method of improving the quality of products made with plastics is provided. The method comprises the steps of (a) providing a plastic container in a chamber; (b) providing a fluorination gas and a second gas in the chamber; (c) exposing the plastic container to the fluorination gas and the second gas for a period of time ranging from 5 minutes to 600 minutes to produce a treated plastic container; (d) evacuating the fluorination gas and the second gas from the chamber; (e) returning the chamber to atmospheric conditions; and (f) removing the treated plastic container from the chamber. The plastic container comprises polyethylene, polypropylene, and/or copolymers thereof. The second gas comprises oxygen and/or a halogen other than fluorine. The treated plastic container comprises less than 25 ppb C5 perfluoroalkyl substances and less than 10 ppb C6 to C20 perfluoroalkyl substances as determined by analyzing a methanol extract for the perfluoroalkyl substances according to modified EPA 537.1. A first treated container sample is the treated plastic container or a first treated smaller analog of the plastic container. Methanol is added to the first treated container sample and the first treated container sample is shaken and/or rotated to ensure the methanol contacts as much of the first treated container sample as possible for a time period of one minute to produce the methanol extract. The second treated container sample is the treated plastic container or a second treated smaller analog of the plastic container. The second treated plastic container sample, filled with a formulation containing an organic ingredient, maintains at least 95% of an initial filled weight after being held at a temperature of 50° C. for 28 days. The organic ingredient is selected from the group consisting of 1,1,1-trichloroethane, xylene, heavy fuel oil, naphtha, toluene, mineral spirits, carbon tetrachloride, and/or turpentine.

It is to be understood that the various aspects of the plastic container, the polyolefin comprising polyethylene, polypropylene, and/or copolymers thereof, the fluorination gas, the second gas, the amount of perfluoroalkyl substances and the testing methods thereof, the amount and type of extractables and the testing methods thereof, the formulations and organic ingredients, the recycle content, the time period wherein the plastic is exposed to the fluorination gas and the second gas, the ratio of the partial pressure of fluorine gas (P_{FG}) to the partial pressure of the second gas (P_{SG}) the chamber pressure, the chamber temperature, and the toluene uptake test herein above apply to the present embodiment as well.

In some aspects, the treated plastic container comprises less than 100 ppb perfluoroalkyl substances. In some aspects, the treated plastic article is tested for the perfluoroalkyl substances using a first solvent consisting essentially of a 50/50 mixture of methanol and ammonia-methanol (0.6%) or the first solvent consists essentially of methanol. The first solvent and a first treated sample which weighs at least one gram are sonicated for a period of two hours at a temperature of 60° C. producing a first solvent extract. The first solvent extract is analyzed for the perfluoroalkyl substances based upon standard CEN/TS 15968:2010. In some aspects, the plastic container ranges in size from 0.5 ml to 10,000 liters.

In some aspects, during the exposing step (c) a ratio of the partial pressure of fluorine equivalents (P_{F}) to the partial pressure of the second gas (P_{SG}) in the chamber ranges from 3:1 to 35:1, a temperature in the chamber ranges from 0° C. to 150° C. or from 25° C. to 80° C., and a total pressure in the chamber ranges from 1 mmHg to 1520 mmHg.

In some aspects, wherein the plastic container comprises high-density polyethylene (HDPE).

In some aspects, a second treated sample and a second untreated sample are substantially similar in size and each weigh at least 300 mg and a first portion of a second solvent and a second portion of the second solvent are substantially similar in volume. The total weight of a first set of extractable components divided by a total weight of the second set of extractable components, on a percentage basis, is less than 20%. The first portion of the second solvent is exposed to the second treated sample, whereby the first portion of the second solvent comprises the first set of extractable components from the second treated sample and the second portion of the second solvent is exposed to the second untreated sample, whereby the second portion of the second solvent comprises the second set of extractable components from the second untreated sample. An amount of the first set of extractable components in the first portion of the second solvent and an amount of the second set of extricable components in the second portion of the second solvent are each measured using liquid chromatography-mass spectroscopy (LC-MS). The solvent is selected from the group consisting of hexane, xylene, methanol, ammonia, toluene, mineral spirits, and/or water. The extractable components are selected from the group consisting of perfluoroalkyl substances, limonene, Beta pinene, Acetic acid hexyl ester, 1-dodecene, Eucalyptol, L-alpha-Terpineol, Octanal, Nonanal, Decanal, Acetic acid phenylmethyl ester, Heptanoate, Benzene, 1-ethyl-3,5-dimethyl-, Naphthalene, and/or Benzyl alcohol.

In some aspects, a third treated sample is, a) weighed, b) sealed in a glass jar with 150 ml of toluene for 2 hours at 25° C., c) dried with a cloth, and d) re-weighed to determine a toluene absorption of the third treated sample; and a third untreated sample is, a) weighed, b) sealed in a glass jar with 150 ml of toluene held for 2 hours at 25° C., c) dried with a cloth, and d) re-weighed to determine a toluene absorption of the third untreated sample. In some aspects, the third treated sample is a nominal 3.5-gram piece of the treated plastic article, and the third untreated sample is a nominal 3.5-gram piece of the plastic article. In some aspects, the plastic article comprises HDPE, and the percent weight increase of the third treated sample divided by the percent weight increase of the third untreated sample is less than 15% , or less than 10%, or less than 8%, or less than 4% or less than 1%.

According to yet another embodiment of the present invention, a method of improving the quality of products made with plastics is provided. The method comprises the steps of (a) providing a plastic container in a chamber; (b) providing a fluorination gas and a second gas in the chamber; (c) exposing the plastic container to the fluorination gas and the second gas for a period of time ranging from 5 minutes to 600 minutes to produce a treated plastic article; (d) evacuating the fluorination gas and the second gas from the chamber; (e) returning the chamber to atmospheric conditions; and (f) removing the treated plastic container from the chamber. The plastic container comprises polyolefin. The second gas comprises oxygen and/or a halogen other than fluorine. During step (c), (i) the temperature in the chamber ranges from 25° C. to 80° C., (ii) the total pressure in the chamber ranges from 1 mmHg to 1520 mmHg, and (iii) the partial pressure of fluorine equivalents (P_{FG}) to a partial pressure of the second gas (P_{SG}) ranges from 3:1 to 35:1. The treated plastic container comprises less than 100 ppb perfluoroalkyl substances as determined by analyzing a solvent extract for the perfluoroalkyl substances based upon standard CEN/TS 15968:2010. The solvent consists essentially of a 50/50 mixture of methanol and ammonia-methanol (0.6%). The solvent and a treated sample weighing at least one gram are sonicated for a period of 2 hours at a temperature of 60° C. to produce the solvent extract. The treated plastic container or a treated smaller analog of the plastic container, filled with a formulation containing an organic ingredient maintains at least 95%, of an initial filled weight after being held at a temperature of 50° C. for 28 days.

It is to be understood that the various aspects of the plastic container, the polyolefin comprising polyethylene, polypropylene, and/or copolymers thereof, the fluorination gas, the second gas, the amount of perfluoroalkyl substances and the testing methods thereof, the amount and type of extractables and the testing methods thereof, the formulations and organic ingredients, the recycle content, the time period wherein the plastic is exposed to the fluorination gas and the second gas, the ratio of the partial pressure of fluorine gas (P_{FG}) to the partial pressure of the second gas (P_{SG}) the chamber pressure, the chamber temperature, and the toluene uptake test herein above apply to the present embodiment as well.

In some aspects, the formulation comprises agricultural chemicals, fuel, fuel additives, cleaners, degreasers, solvents, acetone, d-limonene, terpenes, fragrances, and/or essential oils. In some aspects, the organic ingredient is selected from the group consisting of 1,1,1-trichloroethane, xylene, heavy fuel, naphtha, toluene, mineral spirits, carbon tetrachloride, and turpentine. In some aspects, the organic ingredient is selected from the group consisting of 1,1,1-trichloroethane, xylene, heavy fuel oil, naphtha, toluene, mineral spirits, carbon tetrachloride, and/or turpentine.

### EXAMPLES

High density polyethylene (HDPE) 32 oz containers were obtained and used in Examples 1-5 and are designated Containers A, B, and C. The containers were the same in composition, size, and capacity (e.g., nominally identical). Container A serves as the control and was not subject to any fluorination gas and second gas treatment. High density polyethylene (HDPE) 2.5-gallon container was obtained and used in Examples 6 and 7 and is designated Containers D, E, and F. Container D serves as the control and was not subject to any fluorination gas and second gas treatment.

### Example 1

### Preparation of Container B

An HDPE container was inserted into a chamber. Air was evacuated from the chamber by pulling vacuum until the pressure was 6 mmHg. Nitrogen was then added to the chamber until the pressure was 400 mmHg. Vacuum was again pulled on the chamber until the pressure was 6 mmHg. The chamber was heated to 55° C. by a water jacket system. The pressure in the chamber was increased to 10 mmHg by adding gas comprising of 100 vol % chlorine. The pressure was maintained constant in the chamber for 1 minute to ensure stabilization of pressure measurement. Then the pressure was increased to 210 mmHg by adding a gas comprising 20 vol % fluorine and 80 vol % nitrogen. The pressure was maintained constant in the chamber for 105 minutes. At the end of 105 minutes, the chamber was filled and evacuated three times using atmospheric air. Atmospheric air was fed through the chamber until the chamber pressure was restored to atmospheric pressure.

### Example 2

### Preparation of Container C

Example 1 was repeated with a different set of HDPE containers except for higher oxygen content was used in lieu of chlorine. This was done by using a different vacuum condition. Specifically: air was evacuated from the chamber by pulling vacuum until the pressure 30 mmHg. Then, the pressure was increased to 230 mmHg by adding a gas comprising 20 vol % fluorine and 80 vol % nitrogen. The pressure was maintained constant in the chamber for 105 minutes. At the end of 105 minutes, the chamber was filled and evacuated three times using atmospheric air. Atmospheric air was fed through the chamber until the chamber pressure was restored to atmospheric pressure.

### Example 3

### Toluene Uptake

Nominal 3.5-gram rectangular HDPE samples were cut from each of a Container A, Container B, and Container C. Each sample was weighed and placed in a glass jar with 150 ml of toluene. The jars were sealed and held at 25° C. for one hour. After one hour, each sample was removed from the jar, dried with a cloth, and weighed. The initial and final weights, as well as the % weight increase compared to the control are given in Table 1. As an example, the % weight increase of container B compared to the control is calculated as (% weight increase of Container B/% weight increase of Container A)*100 or (0.4/5.6)*100.

TABLE 1
Toluene Uptake

| | Initial | Final | | % Weight |
|---|---|---|---|---|
| Sample | weight | weight | % Weight | increase compared |
| source | (g) | (g) | increase | to control |
| Container A | 3.455 | 3.649 | 5.6% | 100% |
| Container B | 3.671 | 3.687 | 0.4% | 7.2% |
| Container C | 3.501 | 3.308 | 0.2% | 3.6% |

### Example 4

### Rate of Permeation

One of each of Container A, Container B, and Container C were filled to rated capacity with toluene and sealed with its cap. Each container was weighed, stored at 50° C. for 28 days, and weighed again (analogous to 49 CFR Appendix B to Part 173). The weights and the percent weight loss, based upon the filled container weight, are given in Table 2.

TABLE 2
Rate of Permeation

| | Initial | Final | | % Weight loss |
|---|---|---|---|---|
| Sample | weight | weight | % Weight | compared to |
| source | (g) | (g) | loss | control |
| Container A | 796 | 476 | 40.2% | 100% |
| Container B | 792 | 784 | 1.0% | 2.5% |
| Container C | 788 | 783 | 0.6% | 1.6% |

### Example 5

### Testing for Perfluorooctanoic Acid (PFOA)

Approximately 1-gram samples from each of Containers A, B, and C was spiked with internal standards and mixed with 4 mL of methanol and 4 mL of ammonia-methanol (0.6%). The spiked samples were with extraction solvent were then shaken on an orbital shaker, followed by sonication for two hours at 60° C. and centrifugation. The extract was filtered by solid phase extraction cartridge, with a tube rinse of 2-mL clean MeOH. The final extract volume following the filtration step was approximately 10 mL. An aliquot of the extract was fortified with instrument standards (IS). 10 μL of the fortified aliquot was injected on an LC equipped with a C18 column that was linked to an MS/MS detector. The analytes were separated and identified by comparing the acquired mass spectra and retention times to the reference spectra and retention times for calibration standards acquired under identical LC/MS/MS conditions. The concentration of each analyte was determined using the internal standard isotope dilution technique. The test method level of quantification was 1 ppb. Results for perfluorooctanoic acid (PFOA) are given in Table 3.

TABLE 3

| Sample source | PFOA |
|---|---|
| Container A | Non-detect |
| Container B | Non-detect |
| Container C | Non-detect |

### Example 6

### Preparation of Container E

An HDPE 2.5-gallon container was inserted into a chamber. Air was partially evacuated from the chamber by pulling vacuum until the pressure was 30 mmHg (providing the source of oxygen as the second gas). The chamber was heated to 60° C. by a water jacket system. Then the pressure was increased to 170 mm Hg by adding a gas comprising 20 vol % fluorine and 80 vol % nitrogen. The pressure was maintained constant in the chamber for 75 minutes. At the end of 75 minutes, the chamber was filled and evacuated three times using atmospheric air. Atmospheric air was fed through the chamber until the chamber pressure was restored to atmospheric pressure.

### Example 7

### Preparation of Container F

Example 6 was repeated except that the pressure was increased to 210 mm Hg by adding a gas comprising 20 vol % fluorine and 80 vol % nitrogen.

### Example 8

50 ml of methanol was added to each of Containers D, E, and F, and each container was shaken and rotated for approximately one minute to ensure the methanol covered as much of the container as possible. The methanol extract from each container was decanted into a polypropylene tube and analyzed according to modified EPA 537.1 on a liquid chromatography tandem mass spectrometer. The test method level of quantification was 1 ppb. Results for C4-C12 perfluoro-acids [perfluoro-butonic acid (PFBA), perfluoro-pentanoic acid (PFPeA), perfluoro-hexanoic acid (PFHxA), perfluoro-heptanoic acid (PFHpA), perfluoro-octanoic acid (PFOA), perfluoro-nananoic acid (PFNA), perfluoro-decanoic acid (PFDA), perfluoro-undecanoic acid (PFuDA), perfluoro-dodecanoic acid (PFDoA)] are given in Table 4.

TABLE 4
Methanol extract analysis using EPA method modified EPA 5371

| PFAS | Container D | Container E | Container F |
|---|---|---|---|
| PFBA | ND* | ND | 1 ppb |
| PFPeA | ND | ND | ND |
| PFHxA | ND | ND | ND |
| PFHpA | ND | ND | ND |
| PFOA | ND | ND | ND |
| PFOA | ND | ND | ND |
| PFNA | ND | ND | ND |
| PFDA | ND | ND | ND |
| PFDA | ND | ND | ND |
| PFuDA | ND | ND | ND |
| PFDoA | ND | ND | ND |

*Detection limit of 1 ppb for each compound

A non-limiting listing of embodiments follows.

A1. A method of improving the quality of products made with plastics, the method comprising the steps of:
(a) providing a plastic article in a chamber;
(b) providing a fluorination gas and a second gas in the chamber;
(c) exposing the plastic article to the fluorination gas and the second gas for a period of time ranging from 5 minutes to 600 minutes to produce a treated plastic article.
(d) evacuating the fluorination gas and the second gas from the chamber
(e) returning the chamber to atmospheric conditions; and
(f) removing the treated plastic article from the chamber,
wherein the plastic article comprises polyolefin,
wherein the second gas comprises oxygen and/or a halogen other than fluorine.

A2. The method according to embodiment A1, wherein the treated plastic article comprises less than 150 ppb, or 125 ppb, or 100 ppb, or 90 ppb, or 80 ppb, or 70 ppb, or 60 ppb, or 50 ppb, or 40 ppb, or 35 ppb, or 30 ppb, or 25 ppb, or 20 ppb, or 15 ppb, or 12 ppb, or 10 ppb, or 8 ppb, or 5 ppb, or 2 ppb or 1 ppb perfluoroalkyl substances; wherein a first solvent consists essentially of a 50/50 mixture of methanol and ammonia-methanol (0.6%) or the first solvent consists essentially of methanol; wherein a first treated sample weighs at least one gram; and wherein the first solvent and the first treated sample are sonicated for a period of 2 hours at a temperature of 60° C. producing a first solvent extract, and the first solvent extract is analyzed for the perfluoroalkyl substances based upon standard CEN/TS 15968:2010.

A3. The method according to any of embodiments A1 or A2, wherein the treated plastic article is a treated plastic container, and wherein the treated plastic container comprises less than 25 ppb, or 20 ppb, or 15 ppb, or 12 ppb, or 10 ppb, or 8 ppb, or 5 ppb, or 2 ppb or 1 ppb perfluoroalkyl substances and/or wherein the treated plastic container comprises less than 25 ppb of C5 perfluoroalkyl substances and less than 10 ppb C6 to C20 perfluoroalkyl substances; wherein a first treated container sample is the treated plastic container or a treated smaller analog of the plastic container; wherein methanol is added to the first treated container sample and the first treated container sample is shaken and/or rotated to ensure the methanol contacts as much of the first treated container sample as possible for a time period of one minute, producing a methanol extract; and wherein the methanol extract is analyzed for the perfluoroalkyl substances according to modified EPA 537.1.

A4. The method according to any of embodiments A2 or A3, wherein the treated plastic article comprises less than 10 ppb, or 8 ppb, or 5 ppb, or 2 ppb or 1 ppb or non-detectable C6 to C20 perfluoroalkyl substances; and/or wherein the treated plastic article comprises less than 25 ppb, or 20 ppb, or 15 ppb, or 12 ppb, or 10 ppb, or 8 ppb, or 5 ppb, or 2 ppb or 1 ppb or non-detectable C4 to C5 perfluoroalkyl substances; and/or wherein the treated plastic article comprises less than 25 ppb, or 20 ppb, or 15 ppb, or 12 ppb, or 10 ppb, or 8 ppb, or 5 ppb, or 2 ppb or 1 ppb or non-detectable C4 perfluoroalkyl substances; and/or wherein the treated plastic article comprises less than 25 ppb, or 20 ppb, or 15 ppb, or 12 ppb, or 10 ppb, or 8 ppb, or 5 ppb, or 2 ppb or 1 ppb or non-detectable C5 perfluoroalkyl substances.

A5. The method according to any of embodiments A1-A4, wherein the treated plastic article is suitable for use in packaging a formulation containing an organic ingredient; or wherein the plastic article is a plastic container and a treated plastic container, and/or a treated smaller analog of the plastic container, filled with a formulation containing an organic ingredient maintains at least 95%, or at least 96%, or at least 97%, or at least 98%, or at least 99%, or at least 99.5% or at least 99.9% of an initial filled weight after being held at a temperature of 50° C. for 28 days.

A6. The method according to any of embodiments A1-A5, wherein the plastic article is in the form of a rigid article or a semi-rigid article; or wherein the plastic article is a rigid article selected from the group consisting of bottles, caps, pails, lids, trays, drums, vials, cartridges, intermediate bulk containers (IBC), and tanks; or wherein the plastic article is a semi-rigid article selected from the group consisting of stand-up pouches (SUP) and tubes; or wherein the plastic article is selected from the group consisting of bottles, caps, pails, lids, trays, drums, vials, cartridges, intermediate bulk containers (IBC), fuel tanks, seals, gaskets, and automotive parts.

A7. The method according to any of embodiments A1-A6, wherein the plastic article is a plastic container, and wherein the plastic container ranges in size from 0.5 ml to 20,000 liters, or from 0.5 ml to 10,000 liters, or from 0.5 ml to 5,000 liters, or from 0.5 ml to 2,500 liters, or from 0.5 ml to 1,000 liters, or from 0.5 ml to 500 liters.

A8. The method according to any of embodiments A1-A7, wherein the plastic article comprises a virgin resin and a recycled resin, wherein the recycled resin comprises post-industrial recycled (PIR) resin, and/or post-consumer recycled (PCR) resin, wherein the recycled resin comprises a portion of the polyolefin.

A9. The method according to any of embodiments A1-A8, wherein the polyolefin comprises polyethylene, polypropylene, and/or copolymers thereof; wherein the polyolefin comprises high-density high-molecular-weight polyethylene, high-density polyethylene (HDPE), linear-low-density polyethylene (LLDPE), low-density polyethylene (LDPE) and/or polypropylene; or wherein the polyolefin comprises high-density polyethylene (HDPE), low-density polyethylene (LDPE) and/or polypropylene; or wherein the polyolefin comprises high-density polyethylene (HDPE) and/or low-density polyethylene (LDPE).

A10. The method according to any of embodiments A1-A9, wherein the plastic article is a plastic container, and wherein the plastic container is mono-layered or multi-layered; or wherein the plastic article is a plastic container, and wherein the plastic container is mono-layered; or wherein the plastic article is a plastic container, and wherein the plastic container is multi-layered.

A11. The method according to any of embodiments A1-A10, wherein during the exposing step (c), a ratio of the partial pressure of fluorine equivalents (P_{F}) to the partial pressure of the second gas (P_{SG}) in the chamber ranges from 1:1 to 50:1, or from 3:1 to 35:1 or from 3:1 to 25:1, or from 3:1 to 20:1, or from 3:1 to 15:1, or from 3:1 to 14:1, or from 3:1 to 13:1, or from 3:1 to 12:1, or from 3:1 to 11:1, or from 3:1 to 10:1, or from 3:1 to 9:1, or from 4:1 to 35:1, or from 4:1 to 25:1, or from 4:1 to 20:1, or from 4:1 to 15:1, or from 4:1 to 14:1, or from 4:1 to 13:1, or from 4:1 to 12:1, or from 4:1 to 11:1, or from 4:1 to 10:1, or from 4:1 to 9:1, or from 5:1 to 35:1, or from 5:1 to 25:1, or from 5:1 to 20:1, or from 5:1 to 15:1, or from 5:1 to 14:1, or from 5:1 to 13:1, or from 5:1 to 12:1, or from 5:1 to 11:1, or from 5:1 to 10:1, or from 5:1 to 9:1.

A12. The method according to any of embodiments A1-A11, The method of any of embodiments A1-A11, wherein during the exposing step (c), a temperature in the chamber ranges from 0° C. to 150° C.; or ranges from 0° C. to 125° C.; or ranges from 0° C. to 100° C.; or ranges from 0° C. to 80° C.; or ranges from 25° C. to 150° C.; or ranges from 25° C. to 125° C.; or ranges from 25° C. to 100° C.; or ranges from 25° C. to 80° C.

A13. The method according to any of embodiments A1-A12, wherein a total pressure in the chamber during the exposing step (c) ranges from 1 mmHg to 1520 mmHg; or ranges from 1 mmHg to 1140 mmHg; or ranges from 1 mmHg to 950 mmHg; or ranges from 1 mmHg to 760 mmHg; or ranges from 1 mmHg to 700 mmHg; or ranges from 1 mmHg to 600 mmHg; or ranges from 5 mmHg to 1520 mmHg; or ranges from 5 mmHg to 1140 mmHg; or ranges from 5 mmHg to 950 mmHg; or ranges from 5 mmHg to 760 mmHg; or ranges from 5 mmHg to 700 mmHg; or ranges from 5 mmHg to 600 mmHg; or ranges from 5 mmHg to 500 mmHg; or ranges from 5 mmHg to 400 mmHg; or ranges from 5 mmHg to 300 mmHg; or ranges from 5 mmHg to 200 mmHg; or ranges from 5 mmHg to 100 mmHg; or ranges from 5 mmHg to 50 mmHg; or ranges from 50 mmHg to 1520 mmHg; or ranges from 50 mmHg to 1140 mmHg; or ranges from 50 mmHg to 950 mmHg; or ranges from 50 mmHg to 760 mmHg; or ranges from 50 mmHg to 700 mmHg; or ranges from 50 mmHg to 600 mmHg; or ranges from 50 mmHg to 500 mmHg; or ranges from 50 mmHg to 400 mmHg; or ranges from 50 mmHg to 300 mmHg; or ranges from 50 mmHg to 200 mmHg; or ranges from 100 mmHg to 1520 mmHg; or ranges from 100 mmHg to 1140 mmHg; or ranges from 100 mmHg to 950 mmHg; or ranges from 100 mmHg to 760 mmHg; or ranges from 100 mmHg to 700 mmHg; or ranges from 100 mmHg to 600 mmHg; or ranges from 100 mmHg to 500 mmHg; or ranges from 100 mmHg to 400 mmHg; or ranges from 100 mmHg to 300 mmHg; or ranges from 100 mmHg to 200 mmHg.

A14. The method according to any of embodiments A1-A13, wherein the second gas comprises the halogen other than fluorine, and wherein providing the second gas comprising the halogen other than fluorine consists of feeding a stream of the second gas comprising 1 vol % to 100 vol % of the halogen other than fluorine; or 10 vol % to 100 vol % of the halogen other than fluorine; or 20 vol % to 100 vol % of the halogen other than fluorine; or 30 vol % to 100 vol % the halogen other than fluorine; or 40 vol % to 100 vol % of the halogen other than fluorine in the chamber during step (b).

A15. The method according to any of embodiments A1-A14, wherein the second gas comprises oxygen, and wherein providing the second gas to the chamber comprises a partial evacuation of the chamber before step (b) and/or feeding a stream of the second gas comprising oxygen in the chamber during step (b).

A16. The method according to any of embodiments A1-A15, wherein the plastic article is exposed to the fluorination gas and the second gas for a time period ranging from 5 minutes to 600 minutes; or ranging from 5 minutes to 300 minutes; or ranging from 5 minutes to 150 minutes; or ranging from 5 minutes to 60 minutes; or ranging from 5 minutes to 30 minutes; or ranging from 5 minutes to 20 minutes; or ranging from 10 minutes to 600 minutes; or ranging from 10 minutes to 300 minutes; or ranging from 10 minutes to 150 minutes; or ranging from 10 minutes to 60 minutes; or ranging from 10 minutes to 30 minutes; or ranging from 10 minutes to 20 minutes.

A17. The method according to any of embodiments A1-A16, wherein the fluorination gas comprises 1 vol % to 100 vol % fluorine; or 10 vol % to 100 vol % fluorine; or 20 vol % to 100 vol % fluorine; or 30 vol % to 100 vol % fluorine; or 40 vol % to 100 vol % fluorine.

A18. The method according to any of embodiments A1-A17, wherein the fluorination gas comprises 99 vol % to 0 vol % of an inert gas; or 99 vol % to 10 vol % of an inert gas; 99 vol % to 20 vol % of an inert gas; or 99 vol % to 30 vol % of an inert gas, and wherein the inert gas comprises nitrogen.

A19. The method according to any of embodiments A5-A18, wherein the formulation comprises agricultural chemicals, fuel, fuel additives, cleaners, degreasers, solvents, acetone, d-limonene, terpenes, fragrances, and/or essential oils; or wherein the organic ingredient is selected from the group consisting of 1,1,1-trichloroethane, xylene, heavy fuel, naphtha, toluene, mineral spirits, carbon tetrachloride, and/or turpentine.

A20. The method according to any of embodiments A1-A19, wherein a second treated sample is one of the treated plastic articles; or wherein the second treated sample is a part of one of the treated plastic articles; or wherein a second treated sample is a part of one of the treated plastic articles and the second treated sample weighs at least 300 mg, or at least 1 gram, or at least 10 grams, or at least 20 grams; wherein a first portion of a second solvent is exposed to the second treated sample, whereby the first portion of the second solvent comprises a first set of extractable components from the second treated sample; and wherein an amount of the first set of extractable components in the first portion of the second solvent is measured using liquid chromatography-mass spectroscopy (LC-MS), and wherein the second solvent comprises hexane, xylene, methanol, ammonia-methanol, toluene, mineral spirits, and/or water; or wherein the solvent is selected from the group consisting of hexane, xylene, methanol, ammonia, toluene, mineral spirits, and/or water

A21. The method according to embodiment A20, wherein the extractable components are selected from the group consisting of perfluoroalkyl substances, limonene, Beta pinene, Acetic acid hexyl ester, 1-dodecene, Eucalyptol, L-alpha-Terpineol, Octanal, Nonanal, Decanal, Acetic acid phenylmethyl ester, Heptanoate, Benzene, 1-ethyl-3,5-dimethyl-, Naphthalene, and/or Benzyl alcohol; or wherein the extractable components are selected from the group consisting of perfluoroalkyl substances, limonene, Beta pinene, Acetic acid hexyl ester, and/or 1-dodecene; or wherein the extractable components are selected from the group consisting of Acetic acid hexyl ester, Eucalyptol, L-alpha-Terpineol, Octanal, Nonanal, Decanal, Acetic acid phenylmethyl ester, Heptanoate, Benzene, 1-ethyl-3,5-dimethyl-, Naphthalene, and/or Benzyl alcohol.

A22. The method according to any of embodiments A20 or A21, wherein a second untreated sample is one of the plastic articles; or wherein the second untreated sample is a part of one of plastic articles; or wherein a second untreated sample is a part of one of the plastic articles and the second untreated sample weighs at least 300 mg, or at least 1 gram, or at least 10 grams, or at least 20 grams; and wherein a second portion of the second solvent is exposed to the second untreated sample, and an amount of the second set of extractable components in the second portion of the second solvent is measured using liquid chromatography-mass spectroscopy (LC-MS).

A23. The method according to embodiment A22, wherein the second treated sample and second untreated sample are substantially similar in size, wherein the first portion of the second solvent and the second portion of the second solvent are substantially similar in volume, and wherein a total weight of the first set of extractable components divided by a total weight of the second set of extractable components, on a percentage basis, is less than 1%, or less than 5%, or less than 10% or less than 20% or less than 30% or less than 40% or less than 50% or less than 60%, or less than 70%, or less than 80%.

A24. The method according to any of embodiments A1-A23, wherein a third treated sample is a part of one of the treated plastic articles, wherein a third untreated sample is part of one of the plastic articles, and wherein the third treated sample and the third untreated sample are each a) weighed, b) sealed in a glass jar with 150 ml of toluene held for 2 hours at 25° C., c) dried with a cloth, and d) re-weighed to determine a toluene absorption of the third treated sample and a toluene absorption of the third untreated sample, wherein the third treated sample is a nominal 3.5-gram piece of the treated plastic article, and the third untreated sample is a nominal 3.5-gram piece of the plastic article, wherein the plastic article comprises HDPE, and wherein the percent weight increase of the third treated sample divided by the percent weight increase of the third untreated sample is less than 15%, or less than 10%, or less than 8%, or less than 4%, or less than 1%.

B1. A treated plastic article made by any of the methods of any of embodiments A1-A24.

B2. The treated plastic article according to embodiment B1, wherein the treated plastic article is recyclable.

B3. The treated plastic article according to any of embodiments B1 or B2, wherein the treated plastic article is a treated plastic container.

C1. A method of improving the quality of products made with plastics, the method comprising the steps of:
(a) providing a plastic container in a chamber;
(b) providing a fluorination gas and a second gas in the chamber;
(c) exposing the plastic container to the fluorination gas and the second gas for a period of time ranging from 5 minutes to 600 minutes to produce a treated plastic container.
(d) evacuating the fluorination gas and the second gas from the chamber
(e) returning the chamber to atmospheric conditions; and
(f) removing the treated plastic container from the chamber,
wherein the plastic container comprises polyolefin,
wherein the second gas comprises oxygen and/or a halogen other than fluorine,
wherein, during step (c),
   (i) a temperature in the chamber ranges from 25° C. to 80° C.,
   (ii) a total pressure in the chamber ranges from 1 mmHg to 1520 mmHg, and
   (iii) a partial pressure of fluorine equivalents (P_{FG}) to a partial pressure of the second gas (P_{SG}) ranges from 3:1 to 35:1,
wherein the treated plastic container comprises less than 150 ppb, or 125 ppb, or 100 ppb, or 90 ppb, or 80 ppb, or 70 ppb, or 60 ppb, or 50 ppb, or 40 ppb, or 35 ppb, or 30 ppb, or 25 25 ppb, or 20 ppb, or 15 ppb, or 12 ppb, or 10 ppb, or 8 ppb, or 5 ppb, or 2 ppb or 1 ppb perfluoroalkyl substances as determined by analyzing a solvent extract for the perfluoroalkyl substances based upon standard CEN/TS 15968:2010, wherein the solvent consists essentially of a 50/50 mixture of methanol and ammonia-methanol (0.6%),
wherein a treated sample weighs at least one gram, and
wherein the solvent and the treated sample are sonicated for a period of 2 hours at a temperature of 60° C. producing the solvent extract; and
wherein the treated plastic container, and/or a treated smaller analog of the plastic container, filled with a formulation containing an organic ingredient maintains at least 95%, of an initial filled weight after being held at a temperature of 50° C. for 28 days.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A method of improving the quality of products made with plastics, the method comprising the steps of:
(a) providing a plastic article in a chamber;
(b) providing a fluorination gas and a second gas in the chamber;
(c) exposing the plastic article to the fluorination gas and the second gas for a period of time ranging from 5 minutes to 600 minutes to produce a treated plastic article;
(d) evacuating the fluorination gas and the second gas from the chamber;
(e) returning the chamber to atmospheric conditions; and
(f) removing the treated plastic article from the chamber,
wherein the plastic article comprises polyolefin,
wherein the second gas comprises oxygen and/or a halogen other than fluorine,
wherein the treated plastic article comprises less than 100 ppb perfluoroalkyl substances as determined by analyzing a first solvent extract for the perfluoroalkyl substances based upon standard CEN/TS 15968:2010,
wherein a first solvent consists essentially of a 50/50 mixture of methanol and ammonia-methanol (0.6%),
wherein a first treated sample weighs at least one gram, and
wherein the first solvent and the first treated sample are sonicated for a period of 2 hours at a temperature of 60° C. to produce the first solvent extract.

2. The method of claim 1, wherein the treated plastic article is a treated plastic container, and wherein the treated plastic container comprises less than 25 ppb of C5 perfluoroalkyl substances and less than 10 ppb C6 to C20 perfluoroalkyl substances as determined by analyzing a methanol extract for the perfluoroalkyl substances according to modified EPA 537.1,
wherein a first treated container sample is the treated plastic container or a first treated smaller analog of the plastic container, and
wherein methanol is added to the first treated container sample and the first treated container sample is shaken and/or rotated to ensure the methanol contacts as much of the treated container sample as possible for a time period of one minute, producing the methanol extract.

3. The method of claim 1, wherein the plastic article is a plastic container,
wherein a second treated container sample is the plastic container, and/or a second treated smaller analog of the plastic container,
wherein the second treated container sample, filled with a formulation containing an organic ingredient, maintains at least 95% of an initial filled weight after being held at a temperature of 50° C. for 28 days, and
wherein the formulation comprises agricultural chemicals, fuel, fuel additives, cleaners, degreasers, solvents, acetone, d-limonene, terpenes, fragrances, and/or essential oils.

4. The method of claim 1, wherein the plastic article is selected from the group consisting of bottles, caps, pails, lids, trays, drums, vials, cartridges, intermediate bulk containers (IBC), fuel tanks, seals, gaskets, and automotive parts.

5. The method of claim 1, wherein the plastic article is a plastic container, and wherein the plastic container ranges in size from 0.5 ml to 20,000 liters.

6. The method of claim 1, wherein the polyolefin comprises polyethylene, polypropylene, and/or copolymers thereof.

7. The method of claim 1, wherein during the exposing step (c) a ratio of the partial pressure of fluorine equivalents (P_{F}) to the partial pressure of the second gas (P_{SG}) in the chamber ranges from 1:1 to 50:1, a temperature in the chamber ranges from 0° C. to 150° C., and a total pressure in the chamber ranges from 1 mmHg to 1520 mmHg.

8. The method of claim 1, wherein the second gas comprises the halogen other than fluorine, and
wherein providing the second gas in the chamber comprises feeding a stream of the second gas comprising 1 vol % to 100 vol % of the halogen other than fluorine in the chamber during step (b).

9. The method of claim 1, wherein the second gas comprises oxygen, and
wherein providing the second gas to the chamber comprises a partial evacuation of the chamber before step (b) and/or feeding a stream of the second gas comprising oxygen in the chamber during step (b).

10. The method of claim 1, wherein a second treated sample and a second untreated sample are substantially similar in size and each weigh at least 300 mg,
wherein a first portion of a second solvent and a second portion of the second solvent are substantially similar in volume, and
wherein a total weight of a first set of extractable components divided by a total weight of the second set of extractable components, on a percentage basis, is less than 20%;
wherein the first portion of the second solvent is exposed to the second treated sample, whereby the first portion of the second solvent comprises the first set of extractable components from the second treated sample, and
wherein the second portion of the second solvent is exposed to the second untreated sample, whereby the second portion of the second solvent comprises the second set of extractable components from the second untreated sample, and
wherein an amount of the first set of extractable components in the first portion of the second solvent and an amount of the second set of extricable components in the second portion of the second solvent are each measured using liquid chromatography-mass spectroscopy (LC-MS);
wherein the solvent is selected from the group consisting of hexane, xylene, methanol, ammonia, toluene, mineral spirits, and/or water, and
wherein the extractable components are selected from the group consisting of perfluoroalkyl substances, limonene, Beta pinene, Acetic acid hexyl ester, 1-dodecene, Eucalyptol, L-alpha-Terpineol, Octanal, Nonanal, Decanal, Acetic acid phenylmethyl ester, Heptanoate, Benzene, 1-ethyl-3,5-dimethyl-, Naphthalene, and/or Benzyl alcohol.

11. The method of claim 1, wherein a third treated sample is a nominal 3.5-gram piece of the treated plastic article,
wherein a third untreated sample is a nominal 3.5-gram piece of the untreated plastic article, and
wherein the third treated sample and the third untreated sample are each a) weighed, b) sealed in a glass jar with 150 ml of toluene and held for 2 hours at 25° C., c) dried with a cloth, and d) re-weighed to determine a toluene absorption of the third treated sample and a toluene absorption of the third untreated sample,
wherein the plastic article comprises HDPE, and
wherein the percent weight increase of the third treated sample divided by the percent weight increase of the third untreated sample is less than 15%.

12. A method of improving the quality of products made with plastics, the method comprising the steps of:
(a) providing a plastic container in a chamber;
(b) providing a fluorination gas and a second gas in the chamber;
(c) exposing the plastic container to the fluorination gas and the second gas for a period of time ranging from 5 minutes to 600 minutes to produce a treated plastic container;
(d) evacuating the fluorination gas and the second gas from the chamber;
(e) returning the chamber to atmospheric conditions; and
(f) removing the treated plastic container from the chamber,
wherein the plastic container comprises polyethylene, polypropylene, and/or copolymers thereof,
wherein the second gas comprises oxygen and/or a halogen other than fluorine.
wherein the treated plastic container comprises less than than 25 ppb C5 perfluoroalkyl substances and less than 10 ppb C6 to C20 perfluoroalkyl substances as determined by analyzing a methanol extract for the perfluoroalkyl substances according to modified EPA 537.1,
wherein a first treated container sample is the treated plastic container or a first treated smaller analog of the plastic container,
wherein methanol is added to the first treated container sample and the first treated container sample is shaken and/or rotated to ensure the methanol contacts as much of first the treated container sample as possible for a time period of one minute, producing the methanol extract; and
wherein a second treated container sample is the treated plastic container, and/or a second treated smaller analog of the plastic container,
wherein the second treated container sample, filled with a formulation containing an organic ingredient, maintains at least 95% of an initial filled weight after being held at a temperature of 50° C. for 28 days, and
wherein the organic ingredient is selected from the group consisting of 1,1,1-trichloroethane, xylene, heavy fuel oil, naphtha, toluene, mineral spirits, carbon tetrachloride, and/or turpentine.

13. The method of claim 12, wherein the treated plastic container comprises less than 100 ppb perfluoroalkyl substances as determined by analyzing a first solvent extract for the perfluoroalkyl substances based upon standard CEN/TS 15968:2010,
wherein a first solvent consists essentially of a 50/50 mixture of methanol and ammonia-methanol (0.6%);
wherein a first treated sample weighs at least one gram; and
wherein the first solvent and the first treated sample are sonicated for a period of 2 hours at a temperature of 60° C. to produce the first solvent extract.

14. The method of claim 12, wherein the plastic container ranges in size from 0.5 ml to 10,000 liters.

15. The method of claim 12, wherein during the exposing step (c) a ratio of the partial pressure of fluorine equivalents (P_{F}) to the partial pressure of the second gas (P_{SG}) in the chamber ranges from 3:1 to 35:1, a temperature in the chamber ranges from 0° C. to 150° C., and a total pressure in the chamber ranges from 1 mmHg to 1520 mmHg.

16. The method of claims 15, wherein the temperature in the chamber ranges from 25° C. to 80° C.

17. The method of claim 12, wherein the plastic container comprises high-density polyethylene (HDPE).

18. The method of claim 12, wherein a second treated sample and a second untreated sample are substantially similar in size and each weigh at least 300 mg,
wherein a first portion of a second solvent and a second portion of the second solvent are substantially similar in volume, and
wherein a total weight of a first set of extractable components divided by a total weight of the second set of extractable components, on a percentage basis, is less than 20%;
wherein the first portion of the second solvent is exposed to the second treated sample, whereby the first portion of the second solvent comprises the first set of extractable components from the second treated sample, and
wherein the second portion of the second solvent is exposed to the second untreated sample, whereby the second portion of the second solvent comprises the second set of extractable components from the second untreated sample, and
wherein an amount of the first set of extractable components in the first portion of the second solvent and an amount of the second set of extricable components in the second portion of the second solvent are each measured using liquid chromatography-mass spectroscopy (LC-MS);
wherein the solvent is selected from the group consisting of hexane, xylene, methanol, ammonia, toluene, mineral spirits, and/or water, and
wherein the extractable components are selected from the group consisting of perfluoroalkyl substances, limonene, Beta pinene, Acetic acid hexyl ester, 1-dodecene, Eucalyptol, L-alpha-Terpineol, Octanal, Nonanal, Decanal, Acetic acid phenylmethyl ester, Heptanoate, Benzene, 1-ethyl-3,5-dimethyl-, Naphthalene, and/or Benzyl alcohol.

19. The method of claim 12, wherein a third treated sample is a nominal 3.5-gram piece of the treated plastic container,
wherein a third untreated sample is a nominal 3.5-gram piece of the untreated plastic container, and
wherein the third treated sample and the third untreated sample are each a) weighed, b) sealed in a glass jar with 150 ml of toluene and held for 2 hours at 25° C., c) dried with a cloth, and d) re-weighed to determine a toluene absorption of the third treated sample and a toluene absorption of the third untreated sample, and
wherein the percent weight increase of the third treated sample divided by the percent weight increase of the third untreated sample is less than 15%.

20. A method of improving the quality of products made with plastics, the method comprising the steps of:
(a) providing a plastic container in a chamber;
(b) providing a fluorination gas and a second gas in the chamber;
(c) exposing the plastic container to the fluorination gas and the second gas for a period of time ranging from 5 minutes to 600 minutes to produce a treated plastic container;
(d) evacuating the fluorination gas and the second gas from the chamber;
(e) returning the chamber to atmospheric conditions; and
(f) removing the treated plastic container from the chamber,
wherein the plastic container comprises polyolefin,
wherein the second gas comprises oxygen and/or a halogen other than fluorine,
wherein, during step (c),
(i) a temperature in the chamber ranges from 25° C. to 80° C.,
(ii) a total pressure in the chamber ranges from 1 mmHg to 1520 mmHg, and
(iii) a partial pressure of fluorine equivalents (P_{FG}) to a partial pressure of the second gas (P_{SG}) ranges from 3:1 to 35:1,
wherein the treated plastic container comprises less than 100 ppb, perfluoroalkyl substances as determined by analyzing a solvent extract for the perfluoroalkyl substances based upon standard CEN/TS 15968:2010,
wherein the solvent consists essentially of a 50/50 mixture of methanol and ammonia-methanol (0.6%),
wherein a treated sample weighs at least one gram, and
wherein the solvent and the treated sample are sonicated for a period of 2 hours at a temperature of 60° C. producing the solvent extract; and
wherein the treated plastic container, and/or a treated smaller analog of the plastic container, filled with a formulation containing an organic ingredient, maintains at least 95% of an initial filled weight after being held at a temperature of 50° C. for 28 days.
